(19) United States
(12) Patent Application Publication
(10) Pub. No.: US 2005/0068795 A1
(43) Pub. Date: Mar. 31, 2005

(54) Controlled resonant half-bridge inverter for power supplies and electronic ballasts

(76) Inventor: John G. Konopka, Deer Park, IL (US)

Correspondence Address: Ms. Sandi Basti;Osram Sylvania, Inc., I.P. Law Dept., 100 Endicott St., Danvers, MA, 01923, US

(21) Appl. No.: 10/674,238

(22) Filed: Sep. 29, 2003

(51) Int. Cl. H02M 3/24

(52) U.S. Cl. 363/98

(57) ABSTRACT

A circuit (10) comprises a driven half-bridge inverter (100), a resonant output circuit (300), and a control circuit (400,500). Inverter (100) includes an upper transistor (120), a lower transistor (130), and a driver circuit (200). Control circuit (400,500) monitors a signal (V_{X}) within resonant output circuit (300). In response to the signal (V_{X}) reaching a predetermined level, control circuit (400,500) directs driver circuit (200) to render upper transistor (120) conductive and lower transistor (130) non-conductive for a predetermined first period. Upon completion of the first period, control circuit (400,500) directs driver circuit (200) to render upper transistor (120) non-conductive and lower transistor (130) conductive for a second period. The second period ends when the signal (V_{X}) again reaches the predetermined level.

### FIELD OF THE INVENTION

The present invention relates to the general subjects of power supplies and electronic ballasts for powering discharge lamps. More particularly, the present invention relates to a controlled resonant half-bridge inverter for use in power supplies and electronic ballasts.

### BACKGROUND OF THE INVENTION

Many power supplies and electronic ballasts for discharge lamps include an inverter and a resonant output circuit. Inverters are generally classified according to circuit topology (e.g., half-bridge, push-pull, etc.) and the approach used to control switching of the inverter transistors (e.g., self-oscillating or driven). Inverters that drive a resonant output circuit are sometimes referred to as resonant inverters.

In a number of applications, such as electronic ballasts for gas discharge lamps, driven inverters have come to be preferred over self-oscillating inverters. Although each type of inverter has its advantages, it is generally acknowledged that driven inverters are easier to design and to control. In particular, driven inverters are preferred for ballasts that provide variable illumination (dimming) and/or that include circuitry for protecting the ballast under various fault conditions.

It is known that energy efficiency is optimized when the inverter is operated at the “effective” resonant frequency of the output circuit. The effective resonant frequency varies as the load on the output circuit varies. For example, when the output circuit is unloaded (e.g., with the lamp(s) removed or inoperative), the effective resonant frequency is simply the natural resonant frequency of the output circuit. When the output circuit is fully loaded (e.g., with the lamp(s) operating at rated power), the effective resonant frequency (e.g., 44.5 kilohertz) is significantly lower than the natural resonant frequency (e.g., 48 kilohertz).

Typically, driven resonant inverters are designed so that the switching frequency is set at a value (e.g., 50 kHz) that is somewhat higher than the natural resonant frequency (e.g., 48 kHz). Because of potentially wide variations in the load and in the DC voltage that powers the inverter, this margin is necessary in order to ensure that the switching frequency remains higher than the effective resonant frequency under all loading conditions. Without this margin, the switching frequency may actually end up being less than the effective resonant frequency under certain loading conditions, in which case highly dissipative “hard switching” of the inverter transistors will occur. However, as this margin ensures that the switching frequency will not be equal to the effective resonant frequency, it has the undesirable effect of producing less than optimal inverter efficiency (because, as previously mentioned, inverter efficiency is optimized when the switching frequency is equal to the effective resonant frequency).

What is needed, therefore, is a driven resonant inverter in which the switching frequency automatically tracks the effective resonant frequency under loaded conditions. Such an inverter would provide improved efficiency and would thus represent a significant advance over the prior art.

### BRIEF DESCRIPTION OF THE DRAWINGS

FIG. 1 is a partial block-diagram electrical schematic of a controlled resonant half-bridge inverter, in accordance with a preferred embodiment of the present invention.

FIG. 2 is a detailed electrical schematic of a controlled resonant half-bridge inverter, in accordance with a preferred embodiment of the present invention.

FIG. 3 describes several voltages associated with the operation of the circuit illustrated in FIG. 2, when the upper inverter transistor is operated at an approximately 50% duty cycle, in accordance with a preferred embodiment of the present invention.

### DETAILED DESCRIPTION OF THE PREFERRED EMBODIMENTS

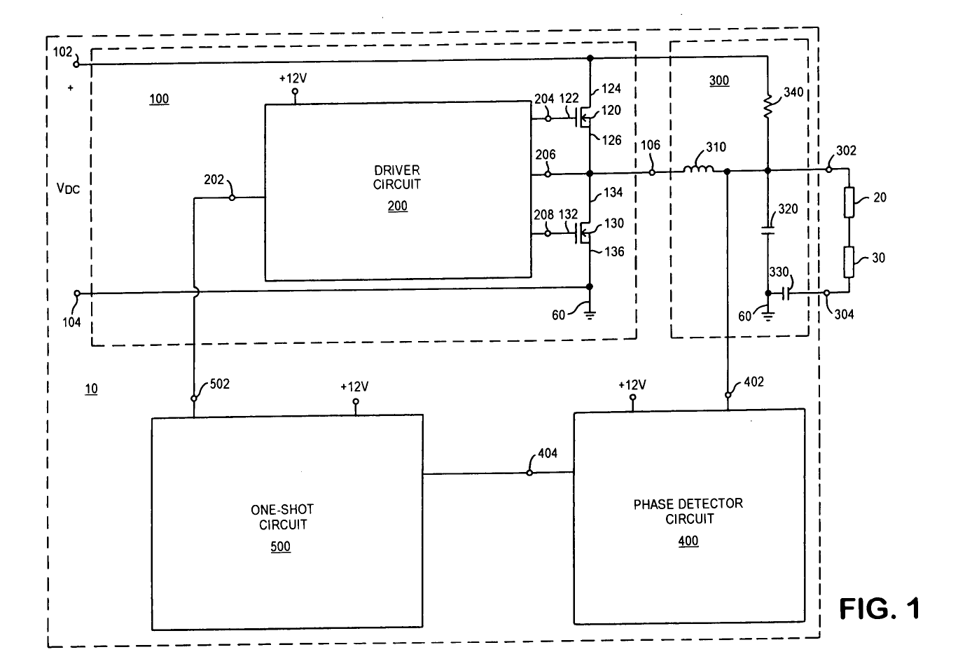

In a preferred embodiment of the present invention, as described in FIG. 1, a circuit 10 includes a driven half-bridge type inverter 100, a resonant output circuit 300, and a control circuit 400,500.

Inverter 100 has an upper transistor 120, a lower transistor 130, and a driver circuit 200 for commutating transistors 120,130 in a substantially complementary manner (i.e., when transistor 120 is on, transistor 130 is off, and vice versa). Resonant output circuit 300 is coupled between inverter 100 and a load. In a preferred application of circuit 10, the load consists of one or more gas discharge lamps 20,30.

Control circuit 400,500 is coupled between resonant output circuit 300 and driver circuit 200 of inverter 100. During operation, control circuit 400,500 monitors a signal within resonant output circuit 300. In response to the signal reaching a predetermined level, control circuit 400,500 directs driver circuit 200 to render upper transistor 120 conductive and lower transistor 130 non-conductive for a predetermined first period. The first period is described as “predetermined” because it is set internally within the control circuit. Upon completion of the first period, control circuit 400,500 directs driver circuit 200 to render upper transistor 120 non-conductive and lower transistor 130 conductive for a second period until such time as the signal within resonant output circuit 300 again reaches the predetermined level. In this way, control circuit 400,500 synchronizes the switching of inverter transistors 120,130 based upon the phase of the signal within resonant output circuit 300. More particularly, control circuit 400,500 ensures that the turn-on of upper transistor 120 and the turn-off of lower transistor 130 are controlled by the phase of the signal within resonant output circuit 300, thus providing an arrangement wherein the switching frequency is automatically adjusted so as to track the effective resonant frequency of output circuit 300. It is believed that these attributes of circuit 10 provide enhanced energy efficiency by reducing the power dissipation in inverter transistors 120,130.

As described in FIG. 1, control circuit 400,500 preferably comprises a phase detector circuit 400 and a one-shot circuit 500.

Phase detector circuit 400 has a detector input 402 and a detector output 404, the latter being coupled to resonant output circuit 300. During operation, phase detector circuit 400 generates a trigger signal at detector output 404 when the monitored signal within resonant output circuit 300 reaches the predetermined level. Preferably, phase detector circuit 400 generates the trigger signal by causing the voltage at detector output 404 to fall below a predetermined trigger threshold for a limited period of time that is substantially less than the first period. After the limited period of time, the voltage at detector output 404 recovers and exceeds the predetermined trigger threshold.

One-shot circuit 500 is coupled between detector output 404 and driver circuit 200. During operation, when phase detector circuit 400 provides the trigger signal, one-shot circuit 500 directs driver circuit 200 to render upper transistor 120 conductive and lower transistor 130 non-conductive for the first period. The first period is set internally within one-shot circuit 500. Preferably, one-shot circuit 500 includes a control output 502 that is coupled to driver circuit 200. During operation, when phase detector circuit 400 provides the trigger signal, one-shot circuit 500 generates a control voltage at control output 502. The control voltage has a duration that is approximately equal to the first period.

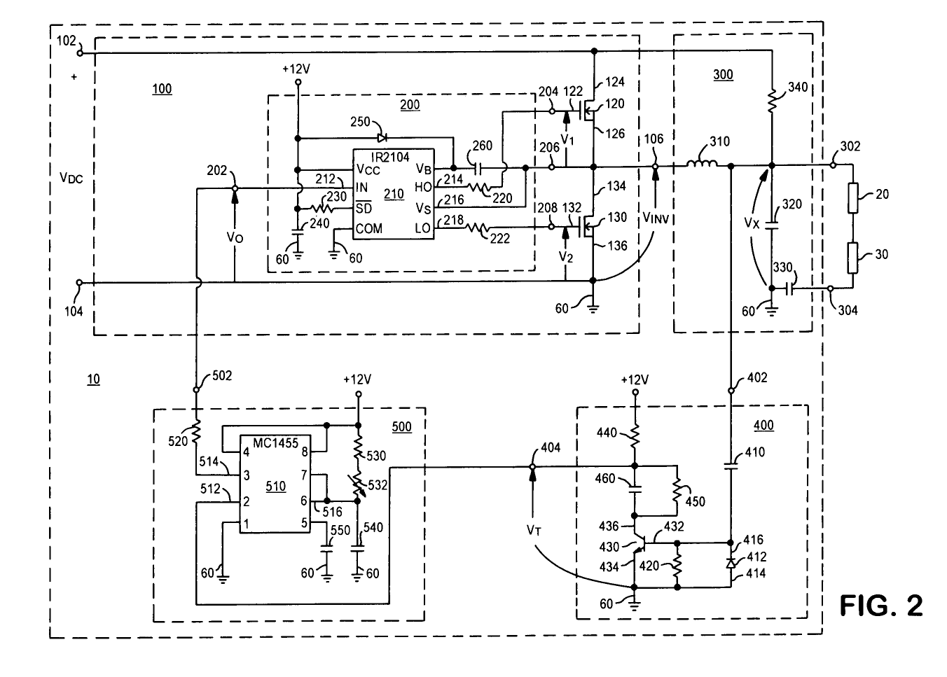

Preferred detailed structures for inverter 100, output circuit 300, phase detector circuit 400, and one-shot circuit 500 are now described with reference to FIG. 2, as follows.

Inverter 100 includes first and second input terminals 102,104, an inverter output terminal 106, an upper transistor 120, a lower transistor 130, and a driver circuit 200. Input terminals 102,104 receive a source of substantially direct current (DC) voltage, V_{DC}. V_{DC} may be provided by any of a number of arrangements known to those skilled in the art; one such arrangement consists essentially of a full-wave rectifier (coupled to a source of conventional 60 hertz alternating current) followed by a boost converter. Second input terminal 104 is coupled to circuit ground 60. Upper transistor 120 is coupled between first input terminal 102 and inverter output terminal 106; more specifically, upper transistor 120 has a drain 124 coupled to first input terminal 102, a source 126 coupled to output terminal 106, and a gate 122 coupled to driver circuit 200. Lower transistor 130 is coupled between inverter output terminal 106 and circuit ground 60; more specifically, lower transistor 130 has a drain 134 coupled to output terminal 106, a source 136 coupled to circuit ground 60, and a gate 132 coupled to driver circuit 200.

Driver circuit 200 has a control input 202 that is coupled to one-shot circuit 500, and a plurality of outputs 204,206,208 that are coupled to inverter transistors 120,130. Preferably, driver circuit 200 is implemented using a commercially available integrated circuit 210, such as the IR2104 high-side driver integrated circuit manufactured by International Rectifier, along with associated peripheral components 220,222,230,240,250,260. As the operation of peripheral components 220,222,230,240,250,260 is explained in application notes and data books pertaining to the IR2104 IC, it is known to those skilled in the art and will not be described in further detail herein. The DC supply voltage, which is depicted as “+12 V” in FIG. 2, may be provided by any of a number of circuits that are well known to those skilled in the art. For example, in those applications where V_{DC} is supplied by a combination of a full-wave rectifier and a boost converter, the DC supply voltage may be derived from the same circuitry that provides operating power to the control circuit for the boost converter.

As shown in FIG. 2, control input 202 of driver circuit 200 is coupled to the “IN” input 212 of integrated circuit 210. During operation, control input 202 receives a control voltage V₀ from one-shot circuit 500 that varies between a low level (e.g., 0 volts) and a high level (e.g., +12 volts). In response to the control voltage being at the high level, integrated circuit 210 provides a high level voltage (e.g., 12 volts) between terminals 204,206 (i.e., V₁) and a low level voltage (e.g., 0 volts) between terminal 208 and circuit ground 60 (i.e., V₂), thereby causing upper transistor 120 to be on and lower transistor 130 to be off. Conversely, when the control voltage is at the low level, integrated circuit 210 sets V₁ low and V₂ high, thereby causing to causing upper transistor 120 to be off and lower transistor 130 to be on. In this way, the control voltage V₀ provided to integrated circuit 210 by one-shot circuit 500 controls the commutation of inverter transistors 120,130.

Referring again to FIG. 2, resonant output circuit 300 comprises first and second output connections 302,304, a resonant inductor 310, a resonant capacitor 320, a direct current (DC) blocking capacitor 330, and a startup resistor 340. Output connections 302,304 are adapted for connection to a load, such as one or more gas discharge lamps 20,30. Resonant inductor 310 is coupled between inverter output terminal 106 and first output connection 302. Resonant capacitor 320 is coupled between first output connection 302 and circuit ground 60. DC blocking capacitor 330 is coupled between second output connection 304 and circuit ground 60. Startup resistor 340 is coupled between first input terminal 102 of inverter 100 and first output connection 302.

During operation, resonant capacitor 320 has a substantially sinusoidal voltage, Vx. Preferably, Vx is the signal that is monitored by phase detector circuit 400, in which case the detector input 402 of phase detector circuit 400 is coupled to first output connection 302. Preferably, phase detector circuit 400 generates the trigger signal when Vx reaches its maximum negative level, or at least within a very short period of time thereafter. When V_{X} is at its maximum negative level, the current flowing through resonant inductor 310 is approximately zero. Thus, upper transistor 120 will be turned on under a substantially zero current condition, which minimizes the switching stress and turn-on switching losses in upper transistor 120.

The basic operation of resonant output circuit 300 is well understood by those skilled in the art and thus will not be further elaborated upon herein. However, the function of startup resistor 340 merits brief description. Startup resistor 340 charges resonant capacitor 320 prior to inverter startup so that, once the inverter starts and lower transistor 130 turns on, current will flow in the resonant circuit. This causes Vx to be sinusoidal (in a transient manner) and thus allows phase detector circuit 400 and one-shot circuit 500 to subsequently turn on upper transistor 120 for the first time. Once upper transistor 120 is turned on for the first time, the resonant circuit receives a substantial amount of energy from the DC source (V_{DC}), at which point the presence of startup resistor 340 is largely immaterial to the operation of circuit 10.

Preferred structures for phase detector circuit 400 and one-shot circuit 500 are now described with reference to FIG. 2.

Phase detector circuit 400 comprises a detector input 402, a detector output 404, a transistor 430, a first capacitor 410, a diode 412, a first resistor 420, a second resistor 440, a second capacitor 460, and a third resistor 450. Transistor 430 is preferably implemented as a NPN-type bipolar junction transistor having a base 432, a collector 436, and an emitter 434. Emitter 434 is coupled to circuit ground 60. First capacitor 410 is coupled between detector input 402 and base 432 of transistor 430. Diode 412 has a cathode 416 coupled to base 432 and an anode 414 coupled to circuit ground 60. First resistor 420 is coupled between base 432 and circuit ground 60. Second resistor 440 is coupled between detector output 404 and a direct current (DC) supply voltage (e.g., +12 volts). Second capacitor 460 and third resistor 450 are each coupled between detector output 404 and collector 436 of transistor 430.

During operation of phase detector circuit 400, capacitor 410 and resistor 420 function as a positive-going slope detector. More specifically, once V_{X} reaches its maximum negative level, the slope of V_{X} begins to go positive and increases with V_{X}. Consequently, an increasing positive current flows into detector input 402 and through capacitor 410 and resistor 420. When the positive current through resistor 420 reaches a certain level, the voltage across resistor 420 becomes high enough (e.g., 0.6 volts) to turn on transistor 430. Transistor 430 will remain on for about as long as the slope of V_{X} remains sufficiently positive to provide enough current to keep the voltage across resistor 420 from falling below about 0.6 volts.

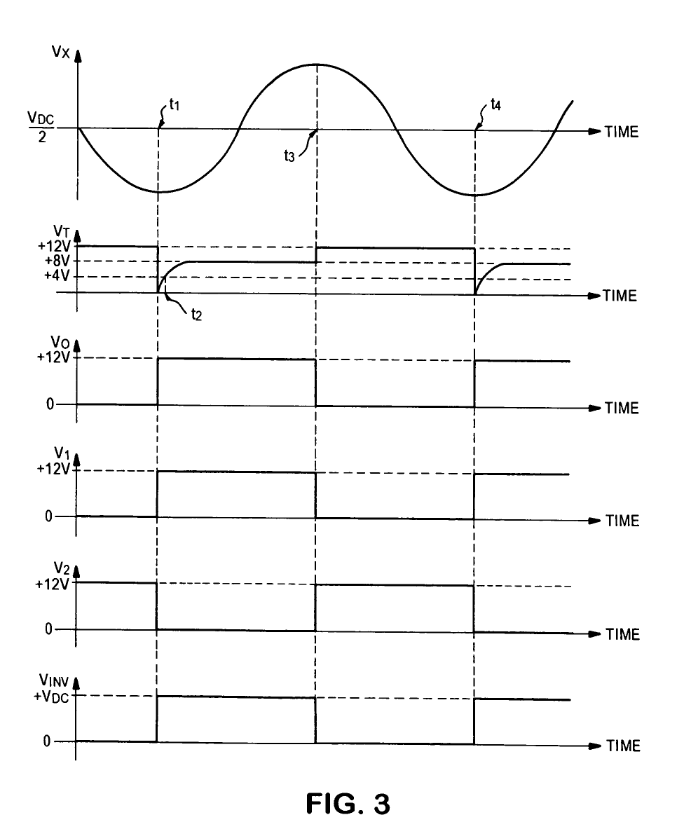

Referring momentarily to FIG. 3, when transistor 430 is first turned on at t=t₁, the voltage V_{T} at detector output 404 is pulled down from +12 volts to zero. As transistor 430 remains on (t₁<t<t₃), V_{T} begins to recover and increases at a rate governed by the values of resistors 440,450 and capacitor 460. Eventually, capacitor 460 peak charges and V_{T} levels off at a certain value (e.g., 8 volts) as determined by the relative values of resistors 440,450. The brief period of time (t₁<t<t₂) during which V_{T} is between zero and 4 volts corresponds to the trigger signal that controls the operation of one-shot circuit 500.

Turning back to FIG. 2, one-shot circuit 500 is preferably implemented as a 555 type timer circuit that is operated in a “monostable” mode; that is, the timer circuit is configured to provide an output voltage that goes high when a suitable momentary trigger voltage is provided, remains high for a predetermined period of time (i.e., the first period), then goes low and remains low for a period of time (i.e., the second period) until the timer is re-triggered. More specifically, in a preferred embodiment, one-shot circuit 500 includes a timer integrated circuit 510 and a timing network 530,532,540. Timer integrated circuit 510, which is preferably realized by a MC1455 integrated circuit manufactured by Motorola, is operated in a monostable mode and has a trigger input 512 (i.e., pin 2), an output 514 (i.e., pin 3), and a timing input 516 (i.e., pin 6). Trigger input 512 is coupled to detector output 404 of phase detector circuit 400. Output 514 is coupled to driver circuit 200 via resistor 520, control output 502 and control input 202. Timing network 530,532,540, which determines the first period, includes a timing resistance 530,532 and a timing capacitance 540. Timing resistance 530,532 is coupled between the DC supply voltage (“+12 V” in FIG. 2) and timing input 516 of timer integrated circuit 510. Timing capacitance 540 is coupled between timing input 516 and circuit ground 60.

During operation of one-shot circuit 500, in the absence of a trigger signal at pin 2 of timer IC 510, the voltage at pin 3 (and, correspondingly, the voltage V₀ at control output 502) will be low (e.g., zero). That is, when V_{T} is greater than about +4 volts (corresponding to one-third the DC supply voltage), V₀ remains at zero. Conversely, when V_{T} falls below +4 volts, timer IC 510 treats that as a trigger signal and causes V₀ to go high (e.g., 12 volts). Once triggered, V₀ will remain at 12 volts for the first period, as set by timing network 530,532,540. Upon expiration of the first period, provided that a trigger signal is not present (i.e., V_{T}>4 volts), V₀ will revert back to zero and remain at zero until such time as a new trigger signal (i.e., V_{T}<4 volts) is provided.

Preferably, timing resistance 530,532 is adjustable; thus, in FIG. 2, resistor 532 is depicted as a variable resistor. The first period may be varied via adjustment of resistor 532. More specifically, an increase in the timing resistance increases the first period and increases the amount of power that is processed by inverter 100 and output circuit 300; conversely, a decrease in the timing resistance decreases the first period and thus reduces the amount of power that is processed by inverter 100 and output circuit 300. Although it is possible to adjust the first period so that the duty cycle of upper transistor 120 is very low (e.g., 10% or lower), in practice it is recommended that the duty cycle of the upper transistor be set at no less than about 30%. In a prototype circuit configured substantially as described herein, it was observed that operation with a duty cycle of less than about 30% for upper transistor 120 produced undesirable hard switching in lower transistor 130.

As a design matter, the timing resistor 532 should be set so that the first period is less than one-half of the period corresponding to the highest effective resonant frequency that will be encountered during operation. For example, if the highest effective resonant frequency that will be encountered during operation is 50 kilohertz (period=1/50,000=20 microseconds), then timing resistor 532 should be set to provide a first period that is less than 10 microseconds. As a consequence of satisfying this design constraint for the first period, the duty cycle of upper transistor 120 will be less than 50% during operation.

Although depicted in FIG. 2 as a series combination of a fixed resistor 530 and a variable resistor 532, it should be appreciated that the timing resistance may be realized by any of a number of alternative circuits known to those skilled in the art. For example, variable resistor 532 may be replaced by a circuit that injects an adjustable amount of current into pin 6 of timer IC 510 so as to reduce the first period and, consequently, reduce the amount of power provided to the load.

The detailed operation of circuit 10 is now explained with reference to FIGS. 2 and 3 as follows.

FIG. 3 gives approximate plots of several voltages that occur during steady-state operation of the circuit of FIG. 2. More specifically: V_{X} is the voltage across resonant capacitor 320; V_{T} is the trigger voltage provided at detection output 404 of phase detector circuit 400; V₀ is the control voltage provided at the control output 502 of one-shot circuit 500 and the control input 202 of driver circuit 200; V₁ is the gate-to-source voltage for upper inverter transistor 120; V₂ is the gate-to-source voltage for lower inverter transistor 130; V_{INV} is the inverter output voltage provided at inverter output terminal 106.

FIG. 3 describes the aforementioned voltages when timing network 530,532,540 is set so as to provide an approximately 50% duty cycle for upper transistor 120; that is, FIG. 3 corresponds to a situation where resistor 532 is set at its maximum value (e.g., 10 kilohms). Resistor 532 may be reduced from its maximum value so as to provide a duty cycle of less than 50% for upper transistor 120, in which case the duty cycle of lower transistor 130 will increase correspondingly. As previously mentioned, it is important that the first period be set such that it does not exceed one-half of the period corresponding to the highest effective resonant frequency that will be encountered during operation, in which case the duty cycle of upper transistor 120 will be somewhat less than 50%.

Referring to FIGS. 2 and 3, prior to t=t₁, V_{T} is at its initial value of 12 volts, V₀ and V₁ are low (i.e., zero), and V₂ is high (i.e., 12 volts). Correspondingly, upper transistor 120 is off, lower transistor 130 is on, and the inverter output voltage V_{INV} is at zero. During the period t<t₁, the slope of V_{X} is negative, so phase detector circuit 400 is prevented from providing a trigger pulse. More specifically, while the slope of V_{X} is negative, only negative current can flow into detector input 402 (i.e., a positive current flows up from circuit ground 60, through diode 412, through capacitor 410, and out of detector input 402), so transistor 430 remains off due to the presence of a negative voltage between base 432 and emitter 434.

At t=t₁, V_{X} reaches its negative peak value and its slope begins to go positive. Consequently, within a very short time after t₁, positive current begins to flow into detector input 402 and through capacitor 410 and resistor 420. Once the positive current reaches a sufficient value (i.e., 600 microamperes or so), the voltage across resistor 420 becomes large enough (i.e., 0.6 volts or so) to turn on transistor 430. With transistor 430 turned on, V_{T} rapidly drops from its initial value of 12 volts to zero. Due to scale limitations, the transition in V_{T} is shown as occurring at t=t₁, but it should be understood that in reality the transition occurs shortly after t=t₁. In response to V_{T} falling below the trigger threshold of 4 volts, the voltage V₀ at the output 514 of timer IC 510 goes high (i.e., 12 volts). Correspondingly, with V₀ at 12 volts, the voltage V₂ provided between the LO output (218) of driver IC 210 and circuit ground 60 goes low (e.g., 0 volts) and lower transistor 130 turns off. At about the same time, the voltage V₁ provided between the HO (214) and VS (216) outputs of driver IC 210 goes high (e.g., 12 volts) and turns on upper transistor 120. Consequently, the inverter output voltage V_{INV} goes from zero to +V_{DC}.

Once triggered by V_{T} falling below 4 volts, V₀ remains high for the duration of the first period (i.e., t₁<t<t₃) as dictated by the values of resistors 520,530 and capacitor 540.

During the time t₁<t<t₂, with transistor 430 turned on, capacitor 460 (which was initially uncharged prior to the turn on of transistor 430) is coupled to circuit ground 60 and begins to charge up from the +12 volt DC supply via resistor 440. Consequently, V_{T} rises at a rate governed by the capacitance of capacitor 460 and the resistances of resistors 440,450. At t=t₂, V_{T} reaches the threshold value of 4 volts, at which point the trigger pulse is no longer supplied to one-shot circuit 500. As a design matter, it is essential to ensure that the duration of the trigger pulse (t₁<t<t₂) is less than the smallest desired value for the first period (t₁<t<t₃). Stated another way, it is essential that V_{T} exceed 4 volts (at t=t₂) well before the end of the first period (at t=t₃). This is required so that, by the time that the first period reaches its end at t=t₃, the trigger pulse (i.e., V_{T}<4 volts) is no longer present and one-shot circuit 500 is thus prevented from operating in an undesirable manner (i.e., turning the upper transistor 120 off for a brief instant but then almost immediately back on again).

After t=t₂, capacitor 460 continues to charge up and V_{T} correspondingly increases until capacitor 460 becomes peak charged (to a voltage determined by the ratio of resistors 440,450), at which point V_{T} reaches its peak value of about 8 volts. V_{T} then remains at about 8 volts for as long as transistor 430 remains on. Transistor 430 remains on for as long as the slope of V_{X} is sufficiently positive to supply enough current to maintain about 0.6 volts across resistor 420.

Shortly before t=t₃, the slope of V_{X} becomes sufficiently small such that the current flowing into detector input 402 becomes insufficient (e.g., less than 600 microamperes) to keep transistor 430 on. Thus, transistor 430 turns off shortly before t=t₃; again, due to scale limitations, this is depicted in FIG. 3 as occurring substantially simultaneously with t=t₃, although in reality it occurs shortly before t=t₃. With transistor 430 off, V_{T} rises to 12 volts and capacitor 460 discharges through resistor 460. V_{T} remains at 12 volts until V_{X} once again reaches its negative peak value (at t=t₄).

Recall that, at t=t₁, one-shot circuit 500 was triggered and V₀ went from zero to 12 volts, causing V₁ to go high (turning on upper transistor 120) and V₂ to go low (turning off lower transistor 130). V₀ remains high until expiration of the first period, as determined by timing network 530,532,540, at t=t3.

At t=t₃, the first period expires and V₀ goes low. Consequently, V₁ goes low (turning off upper transistor 120) and V₂ goes high (turning on lower transistor 130). Correspondingly, V_{INV} drops from +V_{DC} to zero. V₀, V₁, V₂, and V_{INV} then remain at these values until such time as V_{X} once again reaches it negative peak value at t=t4, at which point the aforementioned events are repeated.

Preferred components for implementing inverter 100, driver circuit 200, output circuit 300, phase detector circuit 400, and one-shot circuit 500 are described as follows:

Inverter 100:

Transistors 120,130: IRFBC40

Driver Circuit 200:
Driver IC 210: IR2104 (International Rectifier)
Resistors 220, 222: 33 ohms
Resistor 230: 1 kilohms
Capacitor 240: 0.47 microfarad
Diode 250: 1N4937
Capacitor 260: 0.1 microfarad.
   Output Circuit 300:
Resonant inductor 310: 2.8 millihenry
Resonant capacitor 320: 3.9 nanofarad
DC blocking capacitor 330: 0.1 microfarad
Startup resistor 340: 1 megohm.
   Phase Detector Circuit 400:
Capacitor 410: 220 picofarad
Diode 412: 1N4148
Resistor 420: 1 kilohm
Transistor 430: 2N3904
Resistor 440: 10 kilohm
Resistor 450: 22 kilohm
Capacitor 450: 220 picofarad.
   One-Shot Circuit 510:
Timer IC 510: MC1455 (Motorola)
Resistor 520: 10 kilohm
Resistor 530: 1 kilohm
Resistor 532: 0-10 kilohm (variable)
Capacitor 540: 0.001 microfarad
Capacitor 550: 0.01 microfarad.

In a prototype ballast configured substantially as described herein for powering a 50 watt lamp load, the input power was measured at about 53 watts (versus about 55 watts for a comparable prior art ballast). Thus, circuit 10 is significantly more efficient than comparable prior art circuits.

It is believed that an additional benefit of circuit 10 is that, in the unlikely event of a short circuit across output connections 302,304, inverter switching will cease within one high frequency cycle following occurrence of the short circuit.

Although the present invention has been described with reference to certain preferred embodiments, numerous modifications and variations can be made by those skilled in the art without departing from the novel spirit and scope of this invention.

1. A circuit, comprising:
a driven half-bridge inverter having an upper transistor, a lower transistor, and a driver circuit for commutating the upper transistor and the lower transistor in a substantially complementary manner;
a resonant output circuit coupled between the inverter and a load;
a control circuit coupled between the resonant output circuit and the driver circuit, wherein the control circuit is operable:
(i) to monitor a signal within the resonant output circuit;
(ii) in response to the signal within the resonant output circuit reaching a predetermined level, to direct the driver circuit to render the upper transistor conductive and the lower transistor non-conductive for a predetermined first period; and
(iii) upon completion of the first period, to direct the driver circuit to render the upper transistor non-conductive and the lower transistor conductive for a second period, wherein the second period ends when the signal within the resonant output circuit again reaches the predetermined level.

2. The circuit of claim 1, wherein the control circuit comprises:
a phase detector circuit having a detector input and a detector output, wherein the detector input is coupled to the resonant output circuit, the phase detector circuit being operable, in response to the monitored signal within the resonant output circuit reaching the predetermined level, to generate a trigger signal at the detector output;
a one-shot circuit coupled between the detector output and the driver circuit, the one-shot circuit being operable, in response to the trigger signal, to direct the driver circuit to render the upper transistor conductive for the first period.

3. The circuit of claim 2, wherein the phase detector circuit is further operable to generate the trigger signal by causing the voltage at the detector output to fall below a predetermined trigger threshold.

4. The circuit of claim 3, wherein the phase detector is further operable such that, after the voltage at the detector output falls below the predetermined trigger threshold, the voltage at the detector output recovers and exceeds the predetermined trigger threshold within a time that is substantially less than the first period.

5. The circuit of claim 2, wherein the one-shot circuit includes a control output that is coupled to the driver circuit, the one-shot circuit being operable, in response to the trigger signal, to generate a control voltage at the control output.

6. The circuit of claim 5, wherein the control voltage has a duration that is approximately equal to the first period.

7. The circuit of claim 2, wherein:
the phase detector circuit generates the trigger signal by causing the voltage at the detector output to fall below a predetermined trigger threshold;
the phase detector is further operable such that, after the voltage at the detector output falls below the predetermined trigger threshold, the voltage at the detector output increases and exceeds the predetermined trigger threshold within a time that is substantially less than the first period;
the one-shot circuit includes a control output that is coupled to the driver circuit, the one-shot circuit being operable, in response to the trigger signal, to generate a control voltage at the control output, the control voltage having a duration that is approximately equal to the first period.

8. The circuit of claim 2, wherein:
the inverter further comprises:
first and second input terminals for receiving a source of substantially direct current (DC) voltage, the second input terminal being coupled to circuit ground;
an inverter output terminal, wherein the upper transistor is coupled between the first input terminal and the inverter output terminal, and the lower transistor is coupled between the inverter output terminal and circuit ground;
the driver circuit includes a control input that is coupled to the one-shot circuit;
the resonant output circuit comprises:
first and second output connections adapted for connection to the load;
a resonant inductor coupled between the inverter output terminal and the first output connection;
a resonant capacitor coupled between the first output connection and circuit ground, the resonant capacitor having a voltage thereacross;
a startup resistor coupled between the first input terminal of the inverter and the first output connection; and
a direct current (DC) blocking capacitor coupled between the second output connection and circuit ground;
the monitored signal within the resonant output circuit is the voltage across the resonant capacitor.

9. The circuit of claim 8, wherein:
the detector input of the phase detector circuit is coupled to the first output connection of the resonant output circuit; and
the phase detector circuit is operable to generate the trigger signal shortly after the voltage across the resonant capacitor reaches its most negative level.

10. The circuit of claim 2, wherein the phase detector circuit further comprises:
a transistor having a base, a collector, and an emitter, the emitter being coupled to circuit ground;
a first capacitor coupled between the detector input and the transistor base;
a diode having a cathode coupled to the transistor base and an anode coupled to circuit ground;
a first resistor coupled between the transistor base and circuit ground;
a second resistor coupled between the detector output and a direct current (DC) supply voltage;
a second capacitor coupled between the detector output and the transistor collector; and
a third resistor coupled in parallel with the second capacitor.

11. The circuit of claim 2, wherein the one-shot circuit comprises a 555 type timer that is operated in a monostable mode.

12. The circuit of claim 2, wherein the one-shot circuit comprises:
a timer integrated circuit that is operated in a monostable mode, the timer integrated circuit including: (i) a trigger input that is coupled to the detector output of the phase detector circuit; (ii) an output that is coupled to the driver circuit of the inverter; and (iii) a timing input; and
a timing network that determines the first period, comprising:
a timing resistance coupled between the DC supply voltage and the timing input of the timer integrated circuit; and
a timing capacitance coupled between the timing input and circuit ground.

13. The circuit of claim 12, wherein:
the timing resistance is adjustable;
an increase in the timing resistance increases the first period; and
a decrease in the timing resistance decreases the first period.

14. The circuit of claim 1, wherein the load comprises at least one discharge lamp.

15. A circuit comprising:
an inverter, comprising:
first and second input terminals for receiving a source of substantially direct current (DC) voltage, the second input terminal being coupled to circuit ground;
an inverter output terminal;
a first inverter transistor coupled between the first input terminal and the output terminal;
a second inverter transistor coupled between the inverter output terminal and circuit ground; and
a driver circuit coupled to the first and second inverter transistors, the driver circuit having a control input for receiving a control voltage that varies between a low level and a high level, wherein the driver circuit is operable: (i) in response to the control voltage being at the high level, to cause the first inverter transistor to be on and the second inverter transistor to be off; and (iii) in response to the control voltage being at the low level, to cause the first inverter transistor to be off and the second inverter transistor to be on;
an output circuit, comprising:
first and second output connections adapted for connection to a load;
a resonant inductor coupled between the inverter output terminal and the first output connection;
a resonant capacitor coupled between the first output connection and circuit ground;
a startup resistor coupled between the first input terminal of the inverter and the first output connection; and
a direct current (DC) blocking capacitor coupled between the second output connection and circuit ground;
a control circuit coupled between the first output connection of the output circuit and the control input of the driver circuit, the control circuit being operable:
(a) to monitor the voltage across the resonant capacitor;
(b) in response to the voltage across the resonant capacitor reaching a predetermined level, to set the control voltage at the high level for a predetermined first period; and
(c) upon completion of the predetermined period, to set the control voltage at the low level and maintain the control voltage at the low level for a second period, wherein the second period ends when the voltage across the resonant capacitor again reaches the predetermined level.

16. The circuit of claim 15, wherein the control circuit comprises:
a phase detector circuit having a detector input and a detector output, wherein the detector input is coupled to the first output connection of the output circuit, the phase detector circuit being operable, in response to the voltage across the resonant capacitor reaching the predetermined level, to generate a trigger signal at the detector output, the trigger signal having a duration that is substantially less than the first period; and
a one-shot circuit coupled between the detector output and the driver circuit, the one-shot circuit having a control output coupled to the control input of the driver circuit, the one-shot circuit being operable: (i) in response to the trigger signal, to cause the control voltage to go to the high level for the first period; and (ii) upon completion of the predetermined period, to cause the control voltage to go to the low level and to maintain the control voltage at the low level until such time as another trigger signal is provided by the phase detector at the detector output.

17. The circuit of claim 16, wherein the phase detector circuit further comprises:
a transistor having a base, a collector, and an emitter, the emitter being coupled to circuit ground;
a first capacitor coupled between the detector input and the transistor base;
a diode having a cathode coupled to the transistor base and an anode coupled to circuit ground;
a first resistor coupled between the transistor base and circuit ground;
a second resistor coupled between the detector output and a direct current (DC) supply voltage;
a second capacitor coupled between the detector output and the transistor collector; and
a third resistor coupled in parallel with the second capacitor.

18. The circuit of claim 16, wherein the one-shot circuit further comprises:
a timer integrated circuit that is operated in a monostable mode, the timer integrated circuit including: (i) a trigger input that is coupled to the detector output of the phase detector circuit; (ii) an output that is coupled to the control output; and (iii) a timing input; and
a timing network that determines the first period, comprising:
a timing resistance coupled between the DC supply voltage and the timing input of the timer integrated circuit; and
a timing capacitance coupled between the timing input and circuit ground.

19. The circuit of claim 15, wherein the load comprises at least one discharge lamp.

20. A circuit, comprising:
an inverter, comprising:
first and second input terminals for receiving a source of substantially direct current (DC) voltage, the second input terminal being coupled to circuit ground;
an inverter output terminal;
a first inverter transistor coupled between the first input terminal and the output terminal;
a second inverter transistor coupled between the inverter output terminal and circuit ground; and
a high-side driver circuit coupled to the first and second inverter transistors, the high-side driver circuit having a control input (202) for receiving a control voltage that varies between a low level and a high level, wherein the high-side driver circuit is operable: (i) in response to the control voltage being at the high level, to cause the first inverter transistor to be on and the second inverter transistor to be off; and (iii) in response to the control voltage being at the low level, to cause the first inverter transistor to be off and the second inverter transistor to be on;
an output circuit, comprising:
first and second output connections adapted for connection to a load;
a resonant inductor coupled between the inverter output terminal and the first output connection;
a resonant capacitor coupled between the first output connection and circuit ground;
a startup resistor coupled between the first input terminal of the inverter and the first output connection; and
a direct current (DC) blocking capacitor coupled between the second output connection and circuit ground;
a phase detector circuit, comprising:
a detector input coupled to the first output connection of the output circuit;
a detector output;
a transistor having a base, a collector, and an emitter, the emitter being coupled to circuit ground;
a first capacitor coupled between the detector input and the transistor base;
a diode having a cathode coupled to the transistor base and an anode coupled to circuit ground;
a first resistor coupled between the transistor base and circuit ground;
a second resistor coupled between the detector output and a direct current (DC) supply voltage;
a second capacitor coupled between the detector output and the transistor collector; and
a third resistor coupled in parallel with the second capacitor.
a one-shot circuit, comprising:
a control output coupled to the control input of the high-side driver circuit;
a timer integrated circuit that is operated in a monostable mode, the timer integrated circuit including: (i) a trigger input that is coupled to the detector output of the phase detector circuit; (ii) an output that is coupled to the control output; and (iii) a timing input; and
a timing network, comprising:
a timing resistance coupled between the DC supply voltage and the timing input of the timer integrated circuit; and
a timing capacitance coupled between the timing input and circuit ground.
